(19) United States
(12) Patent Application Publication
(10) Pub. No.: US 2023/0362175 A1
(43) Pub. Date: Nov. 9, 2023

(54) MALICIOUS BEHAVIOR IDENTIFICATION METHOD AND SYSTEM FOR WEIGHTED HETEROGENEOUS GRAPH, AND STORAGE MEDIUM

(71) Applicant: Guangzhou University, Guangzhou City (CN)

(72) Inventors: Shudong LI, Guangzhou City (CN); Xiaobo WU, Guangzhou City (CN); Weihong HAN, Guangzhou City (CN); Binxing FANG, Guangzhou City (CN); Zhihong TIAN, Guangzhou City (CN); Lihua YIN, Guangzhou City (CN); Zhaoquan GU, Guangzhou City (CN)

(21) Appl. No.: 18/140,774

(22) Filed: Apr. 28, 2023

Related U.S. Application Data
(63) Continuation of application No. PCT/CN2021/116161, filed on Sep. 2, 2021.

(30) Foreign Application Priority Data
Oct. 30, 2020 (CN) 202011188125.3

(51) Int. Cl. H04L 41/16; H04L 9/40

(52) U.S. Cl. CPC H04L 63/1416; H04L 41/16

(57) ABSTRACT

The invention discloses a weighted heterogeneous graph-oriented malicious behavior identification method, system and storage medium. The method comprises the following steps: constructing an inductive graph neural network model. The inductive graph neural network model comprises a subgraph extraction module, a plurality of feature vector generation and fusion modules and a classification learning module; performing training and learning for the inductive graph neural network model, extracting subgraphs, learning the latent vector representation of nodes in the subgraphs, obtaining a plurality of subgraph feature vectors corresponding to the subgraphs, and fusing a plurality of subgraph feature vectors. The node feature vector obtained by fusion is used for classification learning in the classification learning module; using the trained inductive graph neural network model for malicious behavior identification. The invention fully combines and utilizes the rich topological feature information and attribute information contained in heterogeneous graphs, and on this basis, an inductive learning graph neural network model is designed to complete feature extraction and representation learning in heterogeneous graphs, and finally malicious behavior identification is realized.

### TECHNICAL FIELD

The invention belongs to the technical field of network security, and in particular relates to a weighted heterogeneous graph-oriented malicious behavior identification method, system and storage medium.

### TECHNICAL BACKGROUND

With rapid development of the Internet, the technology of malware is constantly updated and iterative. The number of malware is increasing day by day, the types and transmission methods are changing with each passing day, and the threat to personal, business and national security is increasing day by day. With continuous confrontations and upgrading of malware attack and defence technologies, malware gradually tends to be in the form of multi-variant, highly concealed, numerous, and fast update. Faced with this network security situation, both academia and industry are constantly seeking the combination of traditional malware detection technology and machine learning, in order to achieve the prevention and detection of a large number of malware attacks with high efficiency and high precision. These methods and technologies may be roughly divided into three types:

Malware identification based on natural language processing technology; this type of method uses text fields in malware data, such as log records, Windows API calls during system runtime, as training data for machine learning, combining with Natural Language Processing (NLP) technology, such as TF-IDF (term frequency-inverse document frequency), Word2Vec etc., performs feature extraction on them, and then uses traditional machine learning models to classify malware.

Malware identification based on image processing technology; this type of method converts executable code segments or binary format of the malware into an image, and on this basis, applies image processing technology such as CNN (Convolutional Neural Network) etc., and uses neural network for automatic feature extraction and classification.

Malware identification based on graph mining technology;

Existing malicious behavior recognition technology based on NLP or image processing is mainly based on the learning and recognition of a single sample’s own attribute features, ignoring potential correlations between samples due to the same type or same source; although some researches have begun to use related technologies in the field of graphs to mine these potentially associated feature information, graph structures constructed by them do not make full use of the relational properties of the graph structure, which may reduce the accuracy of malicious behavior identification tasks; in addition, most of the existing technologies and system models belong to direct push learning. It is often necessary to retrain model parameters for newly added samples, which may lead to slow update speed and poor generalization ability of the model.

### SUMMARY

The main purpose of the present invention is to overcome the shortcomings and deficiencies of the current technologies, and to propose a weighted heterogeneous graph-oriented malicious behavior identification method, system and storage medium. The method uses the weighted heterogeneous graph modelled by the behavioural features of the malware during the execution process as training data, and learns the feature vectors corresponding to nodes from a plurality of subgraphs extracted according to different meta-paths, and then the different learned features are fused and used for classification learning, and finally the model is used for the identification of malicious behavior.

In order to achieve the above objective, the present invention adopts the following technical solutions:

The present invention provides a weighted heterogeneous graph-oriented malicious behavior identification method, comprising following steps:
constructing an inductive graph neural network model, an input of the inductive graph neural network model is a weighted heterogeneous graph constructed based on a malicious behavior data set, an original feature vector of nodes, and a plurality of meta-paths defined on the heterogeneous graph; the inductive graph neural network model comprises a subgraph extraction module, a plurality of feature vector generation and fusion modules, and a classification learning module; each of the feature vector generation and fusion modules comprises a MalSage layer and a subgraph feature fusion layer; the classification learning module comprises a full connection layer and a Softmax layer;
performing a training and a learning for the inductive graph neural network model, inputting training data, the subgraph extraction module extracts the weighted heterogeneous graph into a plurality of corresponding subgraphs according to the meta-paths; obtained subgraphs pass through the MalSage layer to learn representations of the latent vectors of the nodes in the subgraphs to obtain a plurality of subgraph feature vectors corresponding to the subgraphs, and the subgraph feature fusion layer fuses the plurality of subgraph feature vectors into a node feature vector; performing a classification learning on the node feature vector obtained after a plurality of fusions in the feature fusion module in the classification learning module;
performing a malicious behavior identification using a trained inductive graph neural network model.

Preferably, the weighted heterogeneous graph comprises multiple node types and multiple connection relationship types, edges in the weighted heterogeneous graph are all weighted edges, weights of the edges represent a number of occurrences of the connection types; the original feature vector of the node is an One-hot vector of a software-file; the meta-paths refers to a network pattern formed by a node type and one or more connection relationship types.

Preferably, the multiple node types specifically comprise software nodes, file nodes and module nodes; the multiple connection relationship types specifically comprise opening, deleting and loading.

Preferably, the subgraphs extracted by the subgraph extraction module only comprise one connection relationship type represented by the meta-paths.

Preferably, the MalSage layer comprises a plurality of MalConv layers, respectively acting on a plurality of subgraphs;

in the MalSage layer, the subgraphs are all represented by latent vectors of the nodes in a MalConv layer learning subgraph, and for an i-th subgraph, performing a feature vector learning in a corresponding i-th MalConv layer.

Preferably, the feature vector learning is specifically:
for a node u in a subgraph i in the first layer of the MalConv layers, other MalConv layers perform following steps to update their feature vectors:
performing a sampling on neighbor nodes of the node u, and the MalConv layers sample a specific number of k neighbor nodes for each node, if a number of the neighbor nodes of the node u is less than k, then performing a sampling with replacements, otherwise, performing a sampling without replacement until k neighbor nodes are sampled;
performing an aggregation of feature vectors of the neighbor nodes by a method of weighted averaging, for the k neighbor nodes obtained by sampling, performing a weighted average according to weights of their edges to obtain an aggregation vector
$$h {i}_{N \left(u\right)}^{l + 1}$$
of neighbors of node u in a 1+1-th layer:
$$h {i}_{N \left(u\right)}^{l + 1} = \frac{{\sum }_{j ∈ {N}^{′} \left(u\right)} {w}_{u j} h {i}_{j}^{l}}{k}$$

Wherein N′(u) represents a set of neighbor nodes after sampling, wᵤⱼ represents an edge weight of an edge connected between the node u and a node j in subgraph i,

$$h {i}_{j}^{l}$$

represents a feature vector of node j in the subgraph i in the 1-th layer, k is a given number of sampled neighbors;
updating feature vectors of u itself, after performing an aggregation of neighbor feature vectors, splicing
$$h {i}_{N \left(u\right)}^{l + 1}$$
and a feature vector of the node u in the subgraph i in the first layer, and then after a layer of full connection, obtaining a feature vector of the node u in the subgraph in the 1+1-th layer:
$$h {i}_{u}^{l + 1} = σ \left({W}^{l + 1} ⋅ C O N C A T \left(h {i}_{u}^{l} , h {i}_{N \left(u\right)}^{l + 1}\right)\right)$$
wherein W^{l+1}is a weight matrix of a fully connected layer of the 1+1-th layer, σ is an activation function,
$$h {i}_{u}^{l}$$
represents a feature vector of the node u in the 1-th layer.

Preferably, fusing subgraph feature vectors is specifically:
using a splicing method for fusion, for a certain node u, a final node feature vector obtained by updating a 1+1-th layer is:
$${h}_{u}^{l + 1} = σ \left(W ⋅ C O N C A T \left(\left\{h {i}_{u}^{K} , ∀ i ∈ \left\{1 , 2 , … , M\right\}\right\}\right)\right)$$
wherein W is a weight matrix of a fully connected layer when the vectors are fused, σ is an activation function,
$$h {i}_{u}^{K} \text{is}$$
a subgraph feature vector corresponding to a subgraph of node u in the K-th layer.

Preferably, the classification learning is specifically:
using a cross entropy loss function:
$$L o s s = - {\sum }_{i = 1}^{n} {t}_{i} ln {y}_{i}$$
wherein tᵢ represents a true label of the sample, yᵢ represents a Softmax value output by the model, namely:
$${y}_{i} = \frac{{e}^{i}}{{\sum }_{j} {e}^{j}} = 1 - \frac{{\sum }_{j \neq i} {e}^{j}}{{\sum }_{j} {e}^{j}}$$
a gradient update during back propagation is:
$$\begin{matrix}\frac{\partial L o s {s}_{i}}{{\partial }_{i}} = - \frac{\partial l n {y}_{i}}{{\partial }_{i}} \\ = \frac{\partial \left(- l n \frac{{e}^{i}}{{\sum }_{j} {e}^{j}}\right)}{{\partial }_{i}} \\ = - \frac{1}{\frac{{e}^{i}}{{\sum }_{j} {e}^{j}}} ⋅ \frac{\partial \left(\frac{{e}^{i}}{{\sum }_{j} {e}^{i}}\right)}{{\partial }_{i}} \\ = - \frac{{\sum }_{j} {e}^{j}}{{e}^{i}} ⋅ \frac{\partial \left(1 - \frac{{\sum }_{j \neq i} {e}^{j}}{{\sum }_{j} {e}^{j}}\right)}{{\partial }_{i}} \\ = - \frac{{\sum }_{j} {e}^{j}}{{e}^{i}} ⋅ \left(- {\sum }_{j \neq i} {e}^{j}\right) ⋅ \frac{\partial \left(\frac{1}{{\sum }_{j} {e}^{j}}\right)}{{\partial }_{i}} \\ = \frac{{\sum }_{j} {e}^{j} ⋅ {\sum }_{j \neq i} {e}^{j}}{{e}^{i}} ⋅ \frac{- {e}^{i}}{{\left({\sum }_{j} {e}^{j}\right)}^{2}} \\ = - \frac{{\sum }_{j \neq i} {e}^{j}}{{\sum }_{j} {e}^{j}} \\ = - \left(1 - \frac{{e}^{j}}{{\sum }_{j} {e}^{j}}\right) \\ = {y}_{i} - 1 .\end{matrix}$$

The present invention further provides a weighted heterogeneous graph-oriented malicious behavior identification system, applied to the weighted heterogeneous graph-oriented malicious behavior identification method, comprising: a subgraph extraction module, a feature vector generation and fusion module and a classification learning module;
the subgraph extraction module is used to extract a weighted heterogeneous graph of an malicious behaviors input into a plurality of corresponding subgraphs according to an input meta-path;
the feature vector generation and fusion module is used to learn a latent vector representation of nodes in the subgraphs, to obtain a plurality of subgraph feature vectors corresponding to the subgraphs, and to fuse the plurality of subgraph feature vectors into a node feature vector;
the classification learning module is used to classify and learn node feature vectors obtained after the feature vector generation and fusion module fuses multiple times.

The present invention further provides a storage medium storing a program, when the program is executed by one or more processors,the weighted heterogeneous graph-oriented malicious behavior identification method is realized.

Compared with the current technologies, the present invention has the following advantages and beneficial effects:

1. The present invention first adopts a method of subgraph extraction to extract the weighted heterogeneous graph of malicious behavior into subgraphs corresponding to different meta-paths; then, the weighted average aggregation function is used to update the node features in an inductive graph neural network model; the inductive graph neural network model is used to solve the malicious behavior weighted heterogeneous graph-oriented malicious behavior identification problem, and the node information and edge information in the malicious behavior heterogeneous graph are fully utilized, and the accuracy of malicious behavior recognition and the transferability of the model is also improved.

2. The present invention adopts a weighted average aggregation function in the graph neural network model to realize weighted graph-oriented subgraph feature extraction and node representation learning; and using “subgraph extraction-learning subgraph features-fusing subgraph features” method to realise a heterogeneous graph-oriented inductive graph neural network.

### DESCRIPTION OF DRAWINGS

FIG. 1 is a flow chart of a method of the present invention;

FIG. 2 is a structural diagram of an inductive graph neural network model of the present invention;

FIG. 3 is a MalSage layer structural diagram of an inductive graph neural network model of the present invention;

FIG. 4 is a structural diagram of a weighted heterogeneous graph-oriented malicious behavior identification system according to an embodiment of the present invention;

FIG. 5 is a structural diagram of a storage medium according to an embodiment of the present invention.

### DETAILED DESCRIPTION OF EMBODIMENTS

The present invention will be described in further detail below with reference to the embodiments and the accompanying figures, but the embodiments of the present invention are not limited thereto.

In recent years, research in the field of graph mining technology has shown explosive growth. Technologies such as Node2Vec, Metapath2vec, graph neural networks etc. are widely used in recommendation systems, anomaly detection and other fields with good performance. Compared with traditional European data structure, the graph contains one or more types of nodes and connection relationships. In addition to the attribute features of the nodesthemselves, the topology of the graph also contains rich structural information, so it may provide greater possibilities for data mining. In recent years, some researchers have also explored how to convert malware and its features into graphs and apply graph mining technology on them.

A heterogeneous graph is a network structure corresponding to a homogeneous graph. It contains multiple node types or connection types and may represent rich structural information.The use of heterogeneous graphs for modelling malicious behavior is beneficial to represent the association between malware and different feature entities;a graph neural network is a neural network applied to graphs. One of the representative algorithms, GraphSage, is an inductive algorithm that learns the latent vector representation of nodes by aggregating the attribute features of nodes and their neighbors. However, GraphSage is only suitable for representation learning on homogeneous graphs, and if it is directly applied to heterogeneous graphs, the feature information of different nodes and relationship types will be lost.Therefore, the key technical problem to be solved by the present invention is to design a malicious behavior weighted heterogeneous graph-orientedmalicious behavior identification method based on a GraphSage-based model framework.

### DESCRIPTION OF RELATED TECHNICAL TERMS

One-hot vector: One-hot vector, also known as one-hot vector, is generally extracted and generated based on a bag-of-words model, and is specifically expressed as a 0-1 vector of length L, where L represents the size of the corpus.

### Embodiments

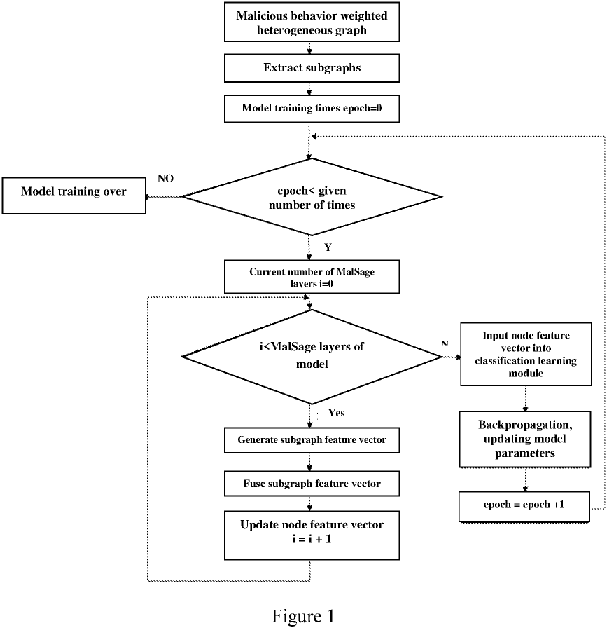

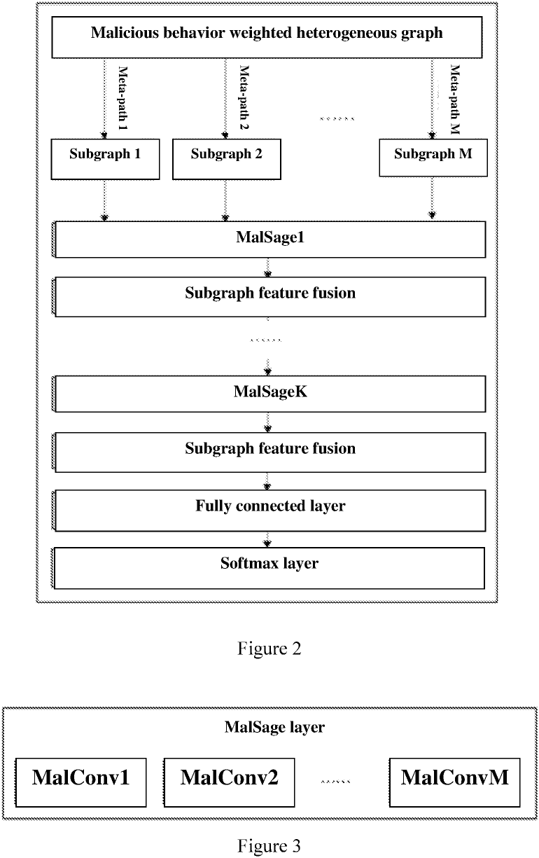

As shown in FIG. 1 and FIG. 2, the present invention,a weighted heterogeneous graph-oriented malicious behavior identification method, comprising following steps:

S1. constructing an inductive graph neural network model, specifically:

In this embodiment, the inductive graph neural network model comprises a subgraph extraction module, a plurality of feature vector generation and fusion modules, and a classification learning module; each of the feature vector generation and fusion modules comprises a MalSage layer and a subgraph feature fusion layer; the MalSage layer comprises M MalConv layers, respectively acting on M subgraphs, see FIG. 3 for details;the classification learning module comprises a full connection layer and a Softmax layer.

In this embodiment, an input of the inductive graph neural network model is a weighted heterogeneous graph constructed based on a malicious behavior data set, an original feature vector of nodes, and a plurality of meta-paths defined on the heterogeneous graph;the weighted heterogeneous graph comprises multiple node types and multiple connection relationship types, multiple node types comprise software nodes, file nodes, and module nodes, etc., and multiple connection types comprise″(software) open (file)″, “(software) delete (file)”, “(software) load (module)” etc.; edges in the weighted heterogeneous graph are all weighted edges, weights of the edges represent a number of occurrences of the connection types; the original feature vector of the node is anOne-hot vector of asoftware-file; the steps of generating the software-file One-hot vector are as follows: first, obtaining all file names in a data set as the corpus, and number these file names. For a certain software, if it has opened file x, the position of the x-th dimension of its One-hot vectoris set to 1, otherwise it is set to 0;the meta-paths refers to a network pattern formed by a node type and one or more connection relationship types, such as “software-open-file- opened-software”.

S2. performing a training and a learning for the inductive graph neural network model. In this embodiment, specifically comprising the following steps:

S21. subgraph extraction.For the malicious behavior weighted heterogeneous graph and M meta-paths of the input model, the inductive graph neural network model extracts the weighted heterogeneous graph into M corresponding subgraphs according to the meta-paths, and each subgraph contains only one connection type, that is, the connection type represented by the meta-path.

S22. subgraph feature vector generation and fusion. The extracted M subgraphs are input into K feature vector generation and fusion modules formed by the MalSage layer and the subgraph feature fusion layer. In the MalSage layer, each subgraph is represented by a graph convolution layer MalConv, which learns the latent vector of the nodes in the subgraph, and obtains M subgraph feature vectors corresponding to the subgraph. The subgraph feature fusion layer fuses the M subgraph feature vectors into a node feature vector, specifically as follows:

S221. The MalSage layer learns the subgraph feature vector. For the node u in the subgraph i in the MalSage1 layer, multiple MalConv layers update the feature vector in three steps:

performing a sampling on neighbor nodes of u. In order to improve computational efficiency, in this embodiment, the MalConv layers sample a specific number of k neighbor nodes for each node,if a number of the neighbor nodes of the node u is less than k, then performing a sampling with replacements, otherwise, performing a sampling without replacement until k neighbor nodes are sampled.

performing an aggregation of feature vectors of the neighbor nodes by a method of weighted averaging, for the k neighbor nodes obtained by sampling, performing a weighted average according to weights of their edges to obtain an aggregation vector

$$h {i}_{N \left(u\right)}^{l + 1}$$

of neighbors of node u in a 1+1-th layer:

$$h {i}_{N \left(u\right)}^{l + 1} = \frac{{\sum }_{j ∈ {N}^{′} \left(u\right)} {w}_{u j} h {i}_{j}^{l}}{k}$$

whereinN′(u) represents a set of neighbor nodes after sampling, wᵤⱼrepresents an edge weight of an edge connected between the node u and a node j in subgraph i,

$$h {i}_{j}^{l}$$

represents a feature vector of node j in the subgraph i in the 1-th layer.

updating feature vectors of u itself, after performing an aggregation of neighbor feature vectors, splicing

$$h {i}_{N \left(u\right)}^{l + 1}$$

and a feature vector of the node u in the subgraph in the first layer, and then after a layer of full connection, obtaining a feature vector of the node u in the subgraph in the 1+1-th layer:

$$h {i}_{u}^{l + 1} = σ \left({W}^{l + 1} ⋅ C O N C A T \left(h {i}_{u}^{l} , h {i}_{N \left(u\right)}^{l + 1}\right)\right)$$

wherein W^{l+1}is a weight matrix of a fully connected layer of the 1+1-th layer, σ is an activation function,

$$h {i}_{u}^{l} \text{represents}$$

a feature vector of the node u in the 1-th layer.

S222. fusing subgraph feature vectors. For each subgraph, the model learns the feature vector corresponding to the node in the subgraph through a subgraph feature fusion layer. Therefore, after the MalSage layer, the M subgraph feature vectors corresponding to the node need to be processed for fusion, using the method of splicing for fusion:
for a certain node u, a final feature vector obtained by updating a 1+1-th layer is:
$${h}_{u}^{l + 1} = σ \left(W ⋅ C O N C A T \left(\left\{h {i}_{u}^{K} , ∀ i ∈ \left\{1 , 2 , … , M\right\}\right\}\right)\right)$$
wherein W is a weight matrix of a fully connected layer when the vectorsare fused, σ is an activation function,
$$h {i}_{u}^{K} \text{is}$$
a subgraph feature vector corresponding to a subgraph of node u in the K-th layer.

S23.classification learning, input the node feature vector obtained after the K-th fusion into the fully connected layer and the Softmax layer for classification learning.In this embodiment, specifically:
using a cross entropy loss function:
$$L o s s = - {\sum }_{i = 1}^{n} {t}_{i} ln {y}_{i}$$
wherein tᵢ represents a true label of the sample, yᵢ represents a Softmax value output by the model, namely:
$${y}_{i} = \frac{{e}^{i}}{{\sum }_{j} {e}^{j}} = 1 - \frac{{\sum }_{j \neq i} {e}^{j}}{{\sum }_{j} {e}^{j}}$$
a gradient update during back propagation is:
$$\begin{matrix}\frac{\partial L o s {s}_{i}}{{\partial }_{i}} = - \frac{\partial l n {y}_{i}}{{\partial }_{i}} \\ = \frac{\partial \left(- l n \frac{{e}^{i}}{{\sum }_{j} {e}^{j}}\right)}{{\partial }_{i}} \\ = - \frac{1}{\frac{{e}^{i}}{{\sum }_{j} {e}^{j}}} ⋅ \frac{\partial \left(\frac{{e}^{i}}{{\sum }_{j} {e}^{i}}\right)}{{\partial }_{i}} \\ = - \frac{{\sum }_{j} {e}^{j}}{{e}^{i}} ⋅ \frac{\partial \left(1 - \frac{{\sum }_{j \neq i} {e}^{j}}{{\sum }_{j} {e}^{j}}\right)}{{\partial }_{i}} \\ = - \frac{{\sum }_{j} {e}^{j}}{{e}^{i}} ⋅ \left(- {\sum }_{j \neq i} {e}^{j}\right) ⋅ \frac{\partial \left(\frac{1}{{\sum }_{j} {e}^{j}}\right)}{{\partial }_{i}} \\ = \frac{{\sum }_{j} {e}^{j} ⋅ {\sum }_{j \neq i} {e}^{j}}{{e}^{i}} ⋅ \frac{- {e}^{i}}{{\left({\sum }_{j} {e}^{j}\right)}^{2}} \\ = - \frac{{\sum }_{j \neq i} {e}^{j}}{{\sum }_{j} {e}^{j}} \\ = - \left(1 - \frac{{e}^{j}}{{\sum }_{j} {e}^{j}}\right) \\ = {y}_{i} - 1 .\end{matrix}$$

S3. performing a malicious behavior identification using a trained inductive graph neural network model.

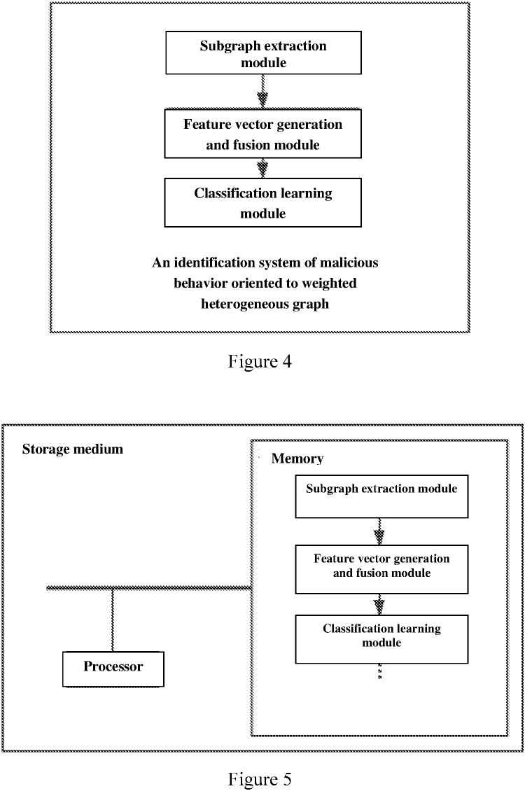

As shown in FIG. 4, in another embodiment, a weighted heterogeneous graph-oriented malicious behavior identificationsystem is provided, and the system includes a subgraph extraction module, a feature vector generation and fusion module and a classification learning module;
the subgraph extraction module is used to extract a weighted heterogeneous graph of an malicious behaviors input into a plurality of corresponding subgraphs according to an input meta-path;
the feature vector generation and fusion module is used to learn a latent vector representation of nodes in the subgraphs, to obtain a plurality of subgraph feature vectors corresponding to the subgraphs, and to fuse the plurality of subgraph feature vectors into a node feature vector;
the classification learning module is used to classify and learn node feature vectors obtained after the feature vector generation and fusion module fuses multiple times.

It should be noted here that the system provided by the above-mentioned embodiments is only illustrated by the division of the above-mentioned functional modules.In practical applications, the above functions may be assigned to different functional modules according to the needs, that is, the internal structure is divided into different functional modules to complete all or part of the functions described above. The system is used for the weighted heterogeneous graph-oriented malicious behavior identification method of the above embodiment.

As shown in FIG. 5, in another embodiment, there is provided a storage medium, which stores a program, and when the program is executed by one or more processors, implements a weighted heterogeneous graph-oriented malicious behavior identification method, specifically:
according to the input meta-path, the weighted heterogeneous graph of the input malicious behavior is extracted into a plurality of corresponding subgraphs;
learning the latent vector representation of nodes in the subgraphs, obtaininga plurality of subgraph feature vectors corresponding to the subgraphs, and fusing the plurality ofsubgraph feature vectors into a node feature vector;
performing classification learning on the node feature vectors obtained after multiple fusions.

It should be understood that various parts of this application may be implemented in hardware, software, firmware, or a combination thereof. In the above-described embodiments, various steps or methods may be implemented in software or firmware stored in memory and executed by a suitable instruction execution system.

It should also be noted that, in this specification, terms such as “comprising”, “including” or any other variation thereof are intended to encompass non-exclusive inclusion, such that a process, method, article or apparatus that includes a series of elements includes not only those elements, but also other elements not expressly listed, or elements inherent to such process, method, article or device. Without further limitation, an element qualified by the phrase “comprising a...” does not preclude the presence of additional identical elements in a process, method, article or apparatus that includes the element.

The above description of the disclosed embodiments enables a person skilled in the art to realise or use the present invention. Various modifications to these embodiments will be readily apparent to a person skilled in the art, and the generic principles defined herein may be implemented in other embodiments without departing from the spirit or scope of the invention. Accordingly, the present invention is not intended to be limited to the embodiments shown herein, but is to be accorded the widest scope consistent with the principles and novel features disclosed herein.

What is claimed is:

1. A weighted heterogeneous graph-oriented malicious behavior identification method, characterized in that, comprising following steps:
constructing an inductive graph neural network model, an input of the inductive graph neural network model is a weighted heterogeneous graph constructed based on a malicious behavior data set, an original feature vector of nodes, and a plurality of meta-paths defined on the heterogeneous graph; the inductive graph neural network model comprises a subgraph extraction module, a plurality of feature vector generation and fusion modules, and a classification learning module; each of the feature vector generation and fusion modules comprises a MalSage layer and a subgraph feature fusion layer; the classification learning module comprises a full connection layer and a Softmax layer;
the MalSage layer comprises a plurality of MalConv layers, respectively acting on a plurality of subgraphs;
in the MalSage layer, the subgraphs are all represented by latent vectors of the nodes in a MalConv layer learning subgraph, and for an i-th subgraph, performing a feature vector learning in a corresponding i-th MalConv layer;
performing a training and a learning for the inductive graph neural network model, inputting training data, the subgraph extraction module extracts the weighted heterogeneous graph into a plurality of corresponding subgraphs according to the meta-paths; obtained subgraphs pass through the MalSage layer to learn representations of the latent vectors of the nodes in the subgraphs to obtain a plurality of subgraph feature vectors corresponding to the subgraphs, and the subgraph feature fusion layer fuses the plurality of subgraph feature vectors into a node feature vector; performing a classification learning on the node feature vector obtained after multiple fusions in the feature fusion module in the classification learning module;
performing a malicious behavior identification using a trained inductive graph neural network model.

2. The weighted heterogeneous graph-oriented malicious behavior identification method according to claim 1, characterized in that, the weighted heterogeneous graph comprises multiple node types and multiple connection relationship types, edges in the weighted heterogeneous graph are all weighted edges, weights of the edges represent a number of occurrences of the connection types; the original feature vector of the node is an One-hot vector of a software-file; the meta-paths refers to a network pattern formed by a node type and one or more connection relationship types.

3. The weighted heterogeneous graph-oriented malicious behavior identification method according to claim 2, characterized in that, the multiple node types specifically comprise software nodes, file nodes and module nodes; the multiple connection relationship types specifically comprise opening, deleting and loading.

4. The weighted heterogeneous graph-oriented malicious behavior identification method according to claim 3, characterized in that, the subgraphs extracted by the subgraph extraction module only comprise one connection relationship type represented by the meta-paths.

5. The weighted heterogeneous graph-oriented malicious behavior identification method according to claim 1, characterized in that, the feature vector learning is specifically:
for a node u in a subgraph i in the first layer of the MalConv layers, other MalConv layers perform following steps to update their feature vectors:
performing a sampling on neighbor nodes of the node u, and the MalConv layers sample a specific number of k neighbor nodes for each node, if a number of the neighbor nodes of the node u is less than k, then performing a sampling with replacements, otherwise, performing a sampling without replacement until k neighbor nodes are sampled;
performing an aggregation of feature vectors of the neighbor nodes by a method of weighted averaging, for the k neighbor nodes obtained by sampling, performing a weighted average according to weights of their edges to obtain an aggregation vector
$$h {i}_{N \left(u\right)}^{l + 1} \text{of}$$
neighbors of node u in a 1+1-th layer:
$$h {i}_{N \left(u\right)}^{l + 1} = \frac{{\sum }_{j ∈ {N}^{′} \left(u\right)} {w}_{u j} h {i}_{j}^{l}}{k}$$
wherein N′(u) represents a set of neighbor nodes after sampling, wᵤⱼrepresents an edge weight of an edge connected between the node u and a node j in subgraph i,
$$h {i}_{j}^{l} \text{represents}$$
a feature vector of node j in the subgraph i in the 1-th layer, k is a given number of sampled neighbors;
updating feature vectors of u itself, after performing an aggregation of neighbor feature vectors, splicing
$$h {i}_{N \left(u\right)}^{l + 1}$$
and a feature vector of the node u in the subgraph i in the first layer, and then after a layer of full connection, obtaining a feature vector of the node u in the subgraph i in the 1+1-th layer:
$$h {i}_{u}^{l + 1} = σ \left({W}^{l + 1} ⋅ C O N C A T \left(h {i}_{u}^{l} , h {i}_{N \left(u\right)}^{l + 1}\right)\right)$$
wherein W^{l+1}is a weight matrix of a fully connected layer of the 1+1-th layer, σ is an activation function,
$$h {i}_{u}^{l} \text{represents}$$
a feature vector of the node u in the 1-th layer.

6. The weighted heterogeneous graph-oriented malicious behavior identification method according to claim 1, characterized in that, the subgraph feature fusion layer fuses the plurality of subgraph feature vectors into one node feature vector is specifically:
using a splicing method for fusion, for a certain node u, a final node feature vector obtained by updating a 1+1-th layer is:
$${h}_{u}^{l + 1} = σ \left(W ⋅ C O N C A T \left(\left\{h {i}_{u}^{K} , ∀ i ∈ \left\{1 , 2 , … , M\right\}\right\}\right)\right)$$
wherein W is a weight matrix of a fully connected layer when the vectors are fused, σ is an activation function,
$$h {i}_{u}^{K}$$
is a subgraph feature vector corresponding to a subgraph of node u in the K-th layer.

7. The weighted heterogeneous graph-oriented malicious behavior identification method according to claim 1, characterized in that, the classification learning is specifically:
using a cross entropy loss function:
$$L o s s = - {\sum }_{i = 1}^{n} {t}_{i} ln {y}_{i}$$
wherein tᵢ represents a true label of the sample, yᵢ represents a Softmax value output by the model, namely:
$${y}_{i} = \frac{{e}^{i}}{{\sum }_{j} {e}^{j}} = 1 - \frac{{\sum }_{j \neq i} {e}^{j}}{{\sum }_{j} {e}^{j}}$$
a gradient update during back propagation is:
$$\begin{matrix}\frac{\partial L o s {s}_{i}}{{\partial }_{i}} = - \frac{\partial l n {y}_{i}}{{\partial }_{i}} \\ = \frac{\partial \left(- l n \frac{{e}^{i}}{{\sum }_{j} {e}^{j}}\right)}{{\partial }_{i}} \\ = - \frac{1}{\frac{{e}^{i}}{{\sum }_{j} {e}^{j}}} ⋅ \frac{\partial \left(\frac{{e}^{i}}{{\sum }_{j} {e}^{j}}\right)}{{\partial }_{i}} \\ = - \frac{{\sum }_{j} {e}^{j}}{{e}^{i}} ⋅ \frac{\partial \left(1 - \frac{{\sum }_{j \neq i} {e}^{j}}{{\sum }_{j} {e}^{j}}\right)}{{\partial }_{i}} \\ = - \frac{{\sum }_{j} {e}^{j}}{{e}^{i}} ⋅ \left(- {\sum }_{j \neq i} {e}^{j}\right) ⋅ \frac{\partial \left(\frac{1}{{\sum }_{j} {e}^{j}}\right)}{{\partial }_{i}} \\ = \frac{{\sum }_{j} {e}^{j} ⋅ {\sum }_{j \neq i} {e}^{j}}{{e}^{i}} ⋅ \frac{- {e}^{i}}{{\left({\sum }_{j} {e}^{j}\right)}^{2}} \\ = - \left(1 - \frac{{e}^{j}}{{\sum }_{j} {e}^{j}}\right) \\ = {y}_{i} - 1 .\end{matrix}$$
.

8. A weighted heterogeneous graph-oriented malicious behavior identification system, characterized in that, it is applied to the weighted heterogeneous graph-oriented malicious behavior identification method according to claim 1, comprising: a subgraph extraction module, a feature vector generation and fusion module and a classification learning module;
the subgraph extraction module is used to extract a weighted heterogeneous graph of an malicious behaviors input into a plurality of corresponding subgraphs according to an input meta-path;
the feature vector generation and fusion module is used to learn a latent vector representation of nodes in the subgraphs, to obtain a plurality of subgraph feature vectors corresponding to the subgraphs, and to fuse the plurality of subgraph feature vectors into a node feature vector;
the classification learning module is used to classify and learn node feature vectors obtained after the feature vector generation and fusion module fuses multiple times.

9. A storage medium storing a program, characterized in that, when the program is executed by one or more processors, the weighted heterogeneous graph-oriented malicious behavior identification method according to claim 1 is realized.
